(19) United States
(12) Patent Application Publication
(10) Pub. No.: US 2024/0182094 A1
(43) Pub. Date: Jun. 6, 2024

(54) HANDCART

(71) Applicant: Mark Andrew Fraser, Brisbane (AU)

(72) Inventor: Mark Andrew Fraser, Brisbane (AU)

(21) Appl. No.: 18/441,455

(22) Filed: Feb. 14, 2024

Related U.S. Application Data
(63) Continuation-in-part of application No. PCT/AU2022/050887, filed on Aug. 12, 2022.

(30) Foreign Application Priority Data
Aug. 24, 2021 (AU) 2021106915
Aug. 24, 2021 (AU) 2021221529

(51) Int. Cl. B62B 3/02

(52) U.S. Cl. CPC B62B 3/02; B62B 2205/00

(57) ABSTRACT

The present invention relates to a collapsible handcart. The handcart includes a collapsible chassis. Retractable ends are provided for retracting toward the chassis. The collapsible chassis may include a pair of hinged front and back frames which collapse together. Advantageously, the frames may be collapsed together which causes the ends to come together whilst remaining substantially upright. Preferably, a user can simply lift the center of the chassis and the ends roll toward each other.

### TECHNICAL FIELD

The present invention relates to a handcart.

### BACKGROUND

The reference to any prior art in this specification is not, and should not be taken as an acknowledgement or any form of suggestion that the prior art forms part of the common general knowledge.

A day at the beach is fun. However, setting up can be an involved job, further complicated when equipment must be carried large distances from the car to the sand.

In recent times, beach handcarts have appeared which assist in carting equipment. However, such carts occupy further storage space in the vehicle and at home.

The preferred embodiment provides a storage-friendly handcart.

### SUMMARY OF THE INVENTION

According to one aspect of the present invention, there is provided a collapsible handcart including:
a collapsible chassis; and
retractable ends for retracting toward the chassis.

Advantageously, frames of the chassis, the ends and a handle may be compactly collapsed together for storage. The ends may be received within respective frames of the chassis so that the collapsed chassis and ends is collectively the width of the frames of the chassis. During collapsing, the handcart may be zigzagged.

The collapsible chassis may include one or more side frames. Each side frame may be articulated to collapse in a plane. Each side frame may be hinged at two separate locations, as well as to the ends. Each side frame may include one or more quadrilaterals with pivots at each corner. Each side frame may include a pair of quadrilaterals, each formed from four pivotally mounted members, which facilitate collapsing of the chassis. The quadrilaterals may be pivotally coupled together and never cross-over thereby forming a compact collapse. Each side frame may include one or more mounting arms extending from each quadrilateral and for pivotally mounting the quadrilaterals together.

Each side frame may include one or more elbows, each elbow including pivotally mounted members. Each side frame may include an upper elbow and a lower elbow. The upper elbow may include a pair of pivotally mounted upper lateral members. The lower elbow may include a pair of pivotally mounted lower lateral members. Each side frame may include one or more connection members for connecting the elbows. Each connection member may be short, and of comparable length to the spacing of the elbows mounted to an end.

Each upper elbow may form at least part of a level load bearing platform. Each upper elbow may include a hinge which restricts hyperextension. Each lower elbow may form an obtuse angle (e.g. about 170°) when the upper elbow forms the level load bearing platform to facilitate support of the platform and increase payload. Each elbow may be pivotally mounted relative to the ends.

The collapsible chassis may include two side frames joined by one or more transverse joiner members. The collapsible chassis may include one or more quadrilaterals with pivots at each corner.

The collapsible chassis may include a pair of hinged front and back frames which collapse together. Advantageously, the frames may be collapsed together which causes the ends to come together whilst remaining substantially upright. Preferably, a user can simply lift the center of the chassis and the ends roll toward each other. Each frame may include one or more quadrilaterals with pivots at each corner.

The front frame may include a pair of front quadrilaterals for pivotally mounting to corresponding rear quadrilaterals of the rear frame. The front quadrilaterals may be connected using one or more transverse joiner members. The front quadrilaterals may include a front one of the ends.

The rear frame may include a pair of rear quadrilaterals for pivotally mounting to corresponding quadrilaterals of the front frame. The rear quadrilaterals may also be connected using one or more transverse joiner members. The rear quadrilaterals may include a rear one of the ends.

The handcart may include a telescopic handle pivotally mounted to the chassis. The handcart may include front and back wheels. The front and back wheels may overlap when the handcart is collapsed. The front wheels may be castors able to swivel. The front wheels may include forks. The rear wheels may be fixed.

The frames may be C-shaped. The ends may be C-shaped. The collapsible chassis may include a chassis restraint for restraining hinging of the frames beyond a certain angle (e.g. 180°). The chassis restraint may include a panel. The chassis may include a handle for lifting to collapse the frames together. The chassis may taper toward the front of the handcart.

The handcart may further include a handle for pulling the handcart. The handle may be retractable toward an end. The handle may be extensible (e.g. telescopic). The handle may be hinged. The handle may be locked in position to extend from the chassis. The handle may include a handle restraint for restraining pivoting of the handle beyond a certain angle (e.g. 180° from the chassis).

The handcart may include wheels for releasably fastening to the chassis. The handcart may include a pair of larger rear wheels and a pair of smaller front wheels. The handcart may include a pair of rear wheels constrained to rotate about a single axis. The handcart may include a pair of front wheels able to rotate about two axes.

The handcart may further include a container for containing items to be carted. The container may be formed from fabric. The container may include a base, and sides and ends extending from the base, all being limp and collapsible. The container may be collapsible. The container may be fastened to the chassis and ends.

According to another aspect of the present disclosure, there is provided a method for collapsing a handcart, the method including:
retracting ends toward a chassis; and
collapsing the chassis.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIGS. 1A-1F show perspective views of the collapsing of a beach handcart;

FIGS. 2A-2F show side views of the collapsing of the beach handcart of FIG. 1;

FIGS. 3A-3D show perspective views of different handle configurations of the collapsing of the beach handcart of FIG. 1;

FIGS. 4A-4D show side views of the different handle configurations of the beach handcart of FIG. 3;

FIG. 5A is a side view of an expanded chassis frame of a handcart in accordance with an embodiment of the present invention;

FIG. 5B is a side view the chassis frame of FIG. 5A in a partially collapsed configuration;

FIG. 5C is a side view the chassis frame of FIG. 5A in a fully collapsed configuration;

FIG. 6A is a side view of an expanded handcart including the frame of FIG. 5A;

FIG. 6B is a side view the handcart of FIG. 6A in a partially collapsed configuration; and

FIG. 6C is a side view the handcart of FIG. 6A in a fully collapsed configuration.

### DETAILED DESCRIPTION OF THE EMBODIMENT(S)

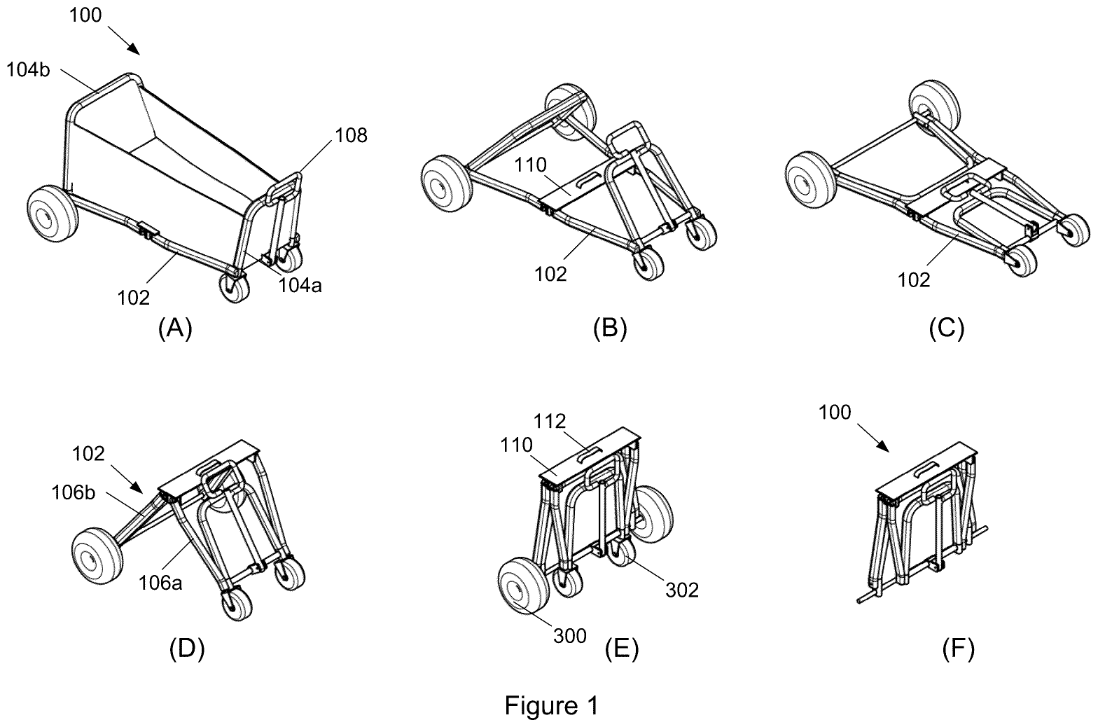

A collapsible handcart 100 is shown in FIG. 1.

The handcart includes a collapsible chassis 102. Front and rear retractable ends 104a, 104b are provided for pivotally retracting toward the chassis 102.

The collapsible chassis 102 includes a pair of front and rear hinged frames 106a, 106b which also collapse together.

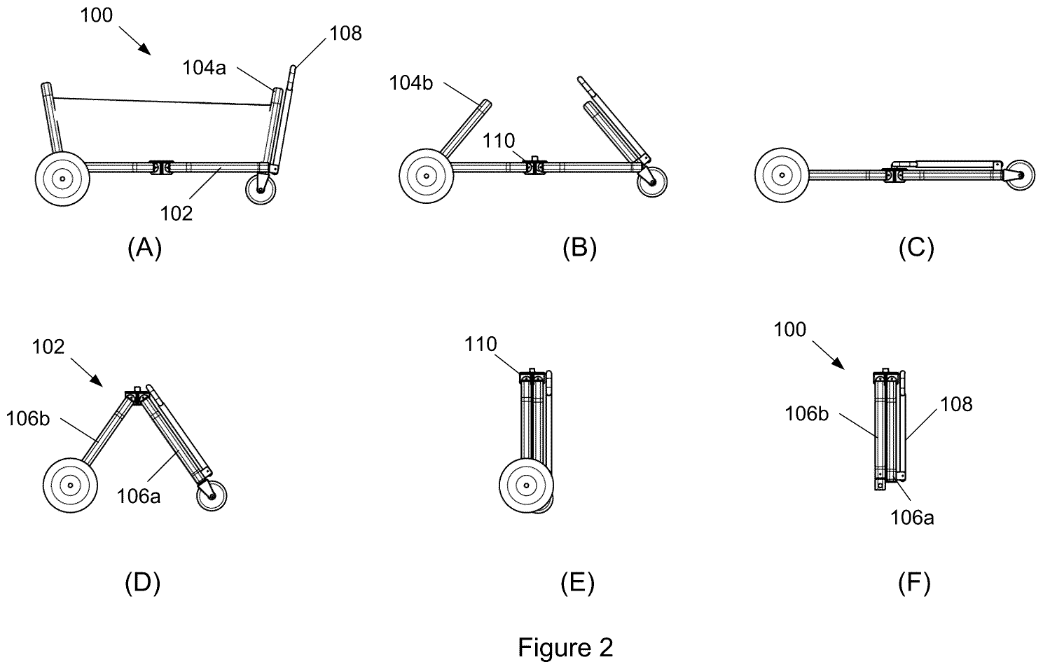

Advantageously, the C-shaped frames 106 of the chassis 102, the C-shaped ends 104 and a handle 108 can be compactly collapsed together for storage (FIG. 2F). The ends 104 are received within respective frames 106 of the folded chassis 102 so that the collapsed chassis 102 and ends 104 is collectively the width of the stacked frames 106 of the chassis 102. Pivot points are arranged so that, during collapsing, the handcart 100 may be zigzagged.

The collapsible chassis 102 includes a chassis restraint 110 for restraining hinging of the chassis frames 106a, 106b open beyond 180°. The chassis restraint 110 includes a strip panel, and a handle 112 extending from the panel for lifting to collapse the frames 106a, 106b together. The expanded chassis 102 tapers toward the front of the handcart 100.

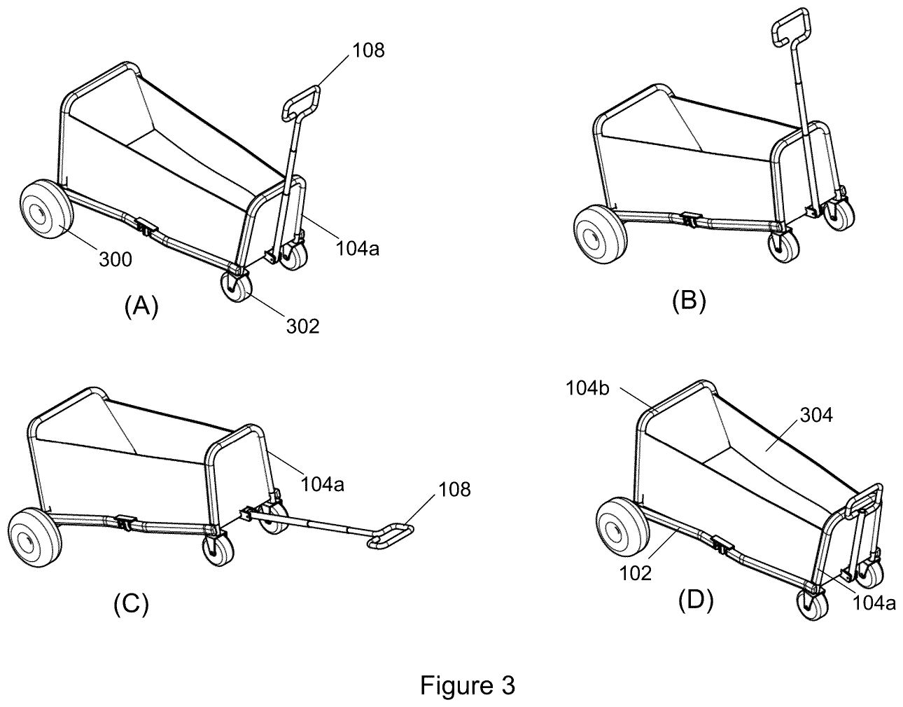

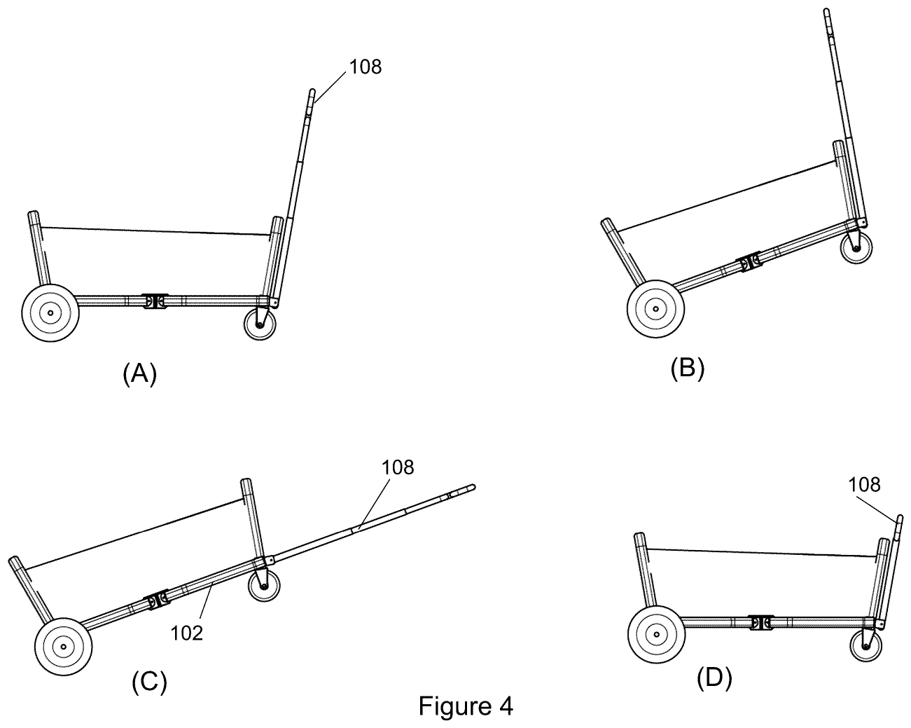

FIG. 3 more clearly shows the main handle 108 for pulling the handcart 100. The handle 108 is hinged to the chassis 102 and is hingedly retractable toward the front end 104a. The handle 108 is also axially extensible, namely being telescopic (FIG. 4D).

FIG. 4C shows that the handle 108 can be locked in position to colinearly extend from the chassis 102 so as to function as a wheel barrow. In this regard, the handle 108 includes a handle restraint for restraining pivoting of the handle 108 beyond a certain angle (e.g. 180° from the chassis 102).

As can best be seen in FIG. 3A, the handcart 100 includes four wheels for releasably fastening to the chassis 102, namely a pair of larger rear wheels 300 and a pair of smaller front wheels 302. The rear wheels 300 are constrained to rotate about a single horizontal axis about a rear axle, whereas the front wheels 302 are able to rotate about horizontal and vertical axes. The front wheels 302 and rear wheels 300 substantially overlap when the chassis 102 is collapsed (FIG. 2E).

As can best be seen in FIG. 3D, the handcart 100 further includes an open box-like container 304 for containing items to be carted. The collapsible container 304 is formed from limp fabric, permanently sewn or releasably fastened to the chassis 102 and ends 104a, 104b. In this manner, the container 304 includes a base, and sides and ends extending from the base, all being limp and collapsible.

A method for collapsing the handcart 100 is briefly described.

Initially as shown in FIG. 1A, the handcart 100 is assembled. The handle 108 can be pivoted to stack against the front end 104a.

The fabric container 304 may be removed, or remain in place.

The ends 104a, 104b are retracted inwardly toward the chassis 102, and are received to sit securely within the chassis frames 106a, 106b as shown in FIGS. 1B-1C.

As shown in FIGS. 1D-1E, the chassis 102 is collapsed whereby the handle 112 is pulled upward and the frames 106a, 106b pivot together. The wheels 300, 302 can roll and support weight during chassis collapsing.

As shown in FIG. 1F, the wheels 300, 302 can be released.

The reverse steps may be performed to assemble the handcart 100.

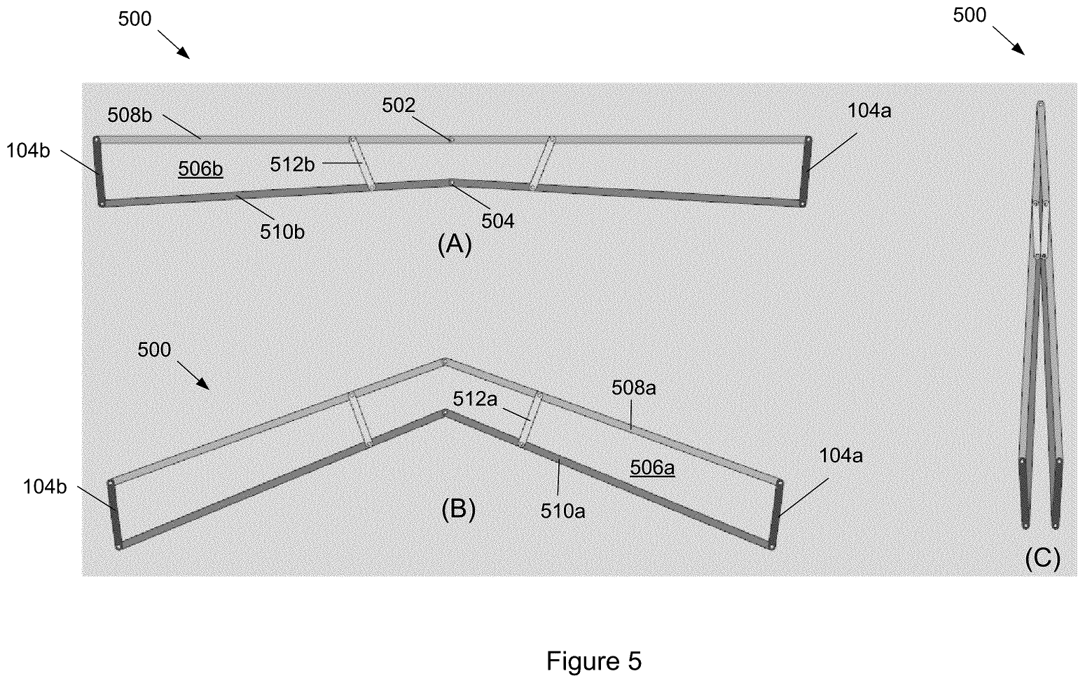

Turning to FIG. 5, the collapsible chassis 102 includes a spaced pair of hinged side frames 500, on either side of the handcart 100. Each articulated frame 500 collapses in on itself in a vertical plane. Each side frame 500 is hinged at two central pivot locations 502, 504, as well as to the ends 104. Each side frame 500 includes a pair of quadrilaterals 506a, 506b. Each quadrilateral 506 is formed from four pivotally mounted members; being an end 104, an upper lateral member 508, a lower lateral member 510 and a connection member 512. These members 104, 508, 510, 512 are all rigid and pivotally mounted at both ends to facilitate collapsing of the chassis 102.

The quadrilaterals 506a, 506b are pivotally coupled together at pivot locations 502, 504, and never cross-over thereby forming a compact collapse as shown in FIG. 5C. Each lateral member 508, 510 extends beyond the quadrilateral 506 to effectively form extended mounting arms for pivotally mounting the quadrilaterals 506 together at the central pivot locations 502, 504.

Each side frame 500 includes an upper elbow formed from pivotally mounted upper lateral members 508a, 508b, and a lower elbow formed from pivotally mounted lower lateral members 510a, 510b. Each side frame 500 includes the two connection members 512a, 512b for connecting the elbows. Each connection member 512 is short, and as can best be seen in FIG. 5B is of comparable length to the spacing of the elbows mounted to an end 104. The shortness of the connection member 512 involves the use of less materials, and the ability to sustain greater forces without bending.

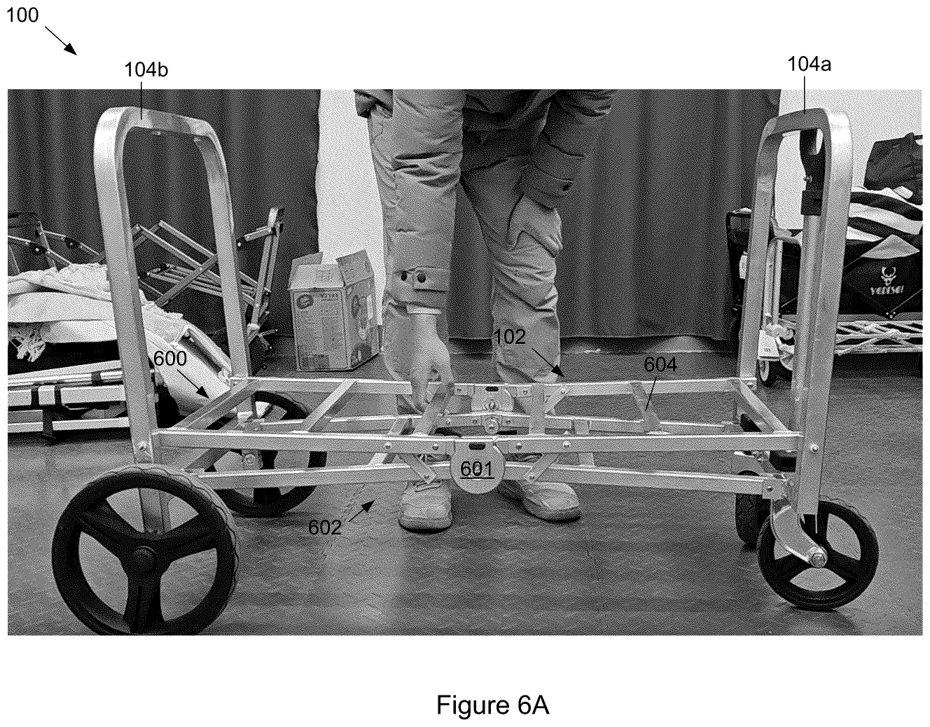

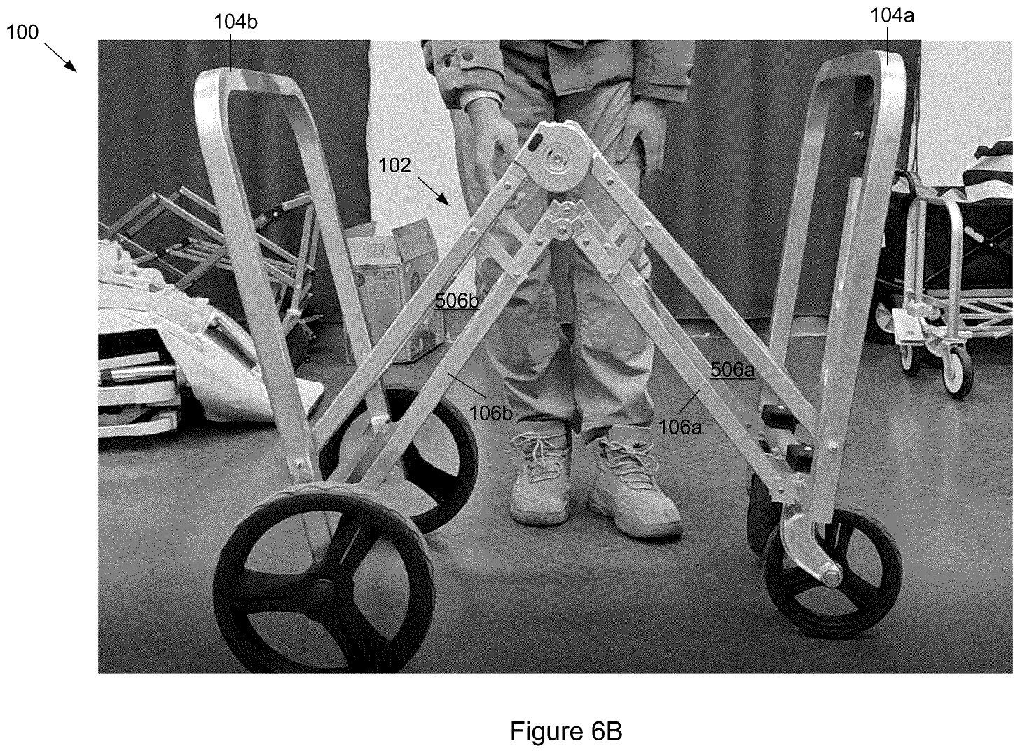

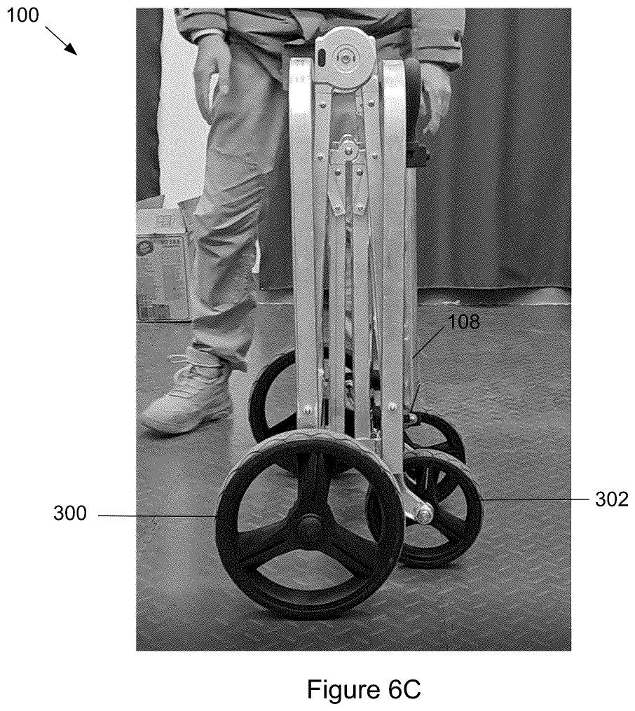

Turning to FIG. 6A, each upper elbow 600 forms a side part of a level load bearing platform. Each upper elbow 600 includes a central hinge 601 which restricts hyperextension (i.e. rotation beyond 180°). Each lower elbow 602 forms an obtuse angle (e.g. about 170°) when the upper elbow 600 forms the level load bearing platform to facilitate support of the platform and increased payload. Each elbow 600, 602 is pivotally mounted relative to the ends 104a, 104b.

The collapsible chassis 102 includes two such spaced apart side frames 500 joined by parallel transverse joiner members 604.

Turning to FIG. 6B, the handcart 100 includes retractable ends 104a, 104b which retract and move back toward the collapsing chassis 102 in a similar way as previously described. As before, the collapsible chassis 102 includes a pair of hinged front and back frames 106a, 106b which collapse together. Advantageously, the frames 106a, 106b are collapsed together which causes the ends 104a, 104b to retract whilst remaining substantially upright. As shown in the sequence of FIGS. 6A to 6C, a user can simply lift the center of the chassis 102 with a single hand, and the ends 104a, 104b roll toward each other.

Returning to FIG. 6B, the front frame 106a includes a pair of front quadrilaterals 506a for pivotally mounting to corresponding rear quadrilaterals 506b of the rear frame 106b. The front quadrilaterals 506a are connected using transverse joiner members 604. The front quadrilaterals 506a include the front end 104a.

Similarly, the rear frame 106b includes a pair of rear quadrilaterals 506b for pivotally mounting to corresponding quadrilaterals 506a of the front frame 106a. The rear quadrilaterals 506b are also connected using transverse joiner members 604. The rear quadrilaterals 506b include the rear end 104b.

As before and shown in FIG. 6C, the handcart 100 include a telescopic handle 108 pivotally mounted to the chassis 102. The handcart 100 includes back wheels 300 and front wheels 302 that overlap when the handcart 100 is collapsed. The front wheels 302 are castors with forks and able to swivel. Instead, the rear wheels 300 are fixed on an axle and cannot swivel. The wheels 300, 302 are quickly releasable.

A person skilled in the art will appreciate that many embodiments and variations can be made without departing from the ambit of the present invention.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

Thus, having described the invention, what is claimed is:

1. A collapsible handcart, including:
a collapsible chassis; and
retractable ends for retracting toward the chassis.

2. A collapsible handcart as claimed in claim 1, wherein the collapsible chassis includes one or more side frames.

3. A collapsible handcart as claimed in claim 2, wherein each side frame is articulated to collapse in a plane.

4. A collapsible handcart as claimed in claim 2, wherein each side frame is hinged at two separate locations, as well as to the ends.

5. A collapsible handcart as claimed in claim 2, wherein each side frame includes one or more quadrilaterals with pivots at each corner.

6. A collapsible handcart as claimed in claim 2, wherein each side frame includes a pair of quadrilaterals, each formed from four pivotally mounted members, which facilitate collapsing of the chassis.

7. A collapsible handcart as claimed in claim 6, wherein the quadrilaterals are pivotally coupled together and never cross-over thereby forming a compact collapse.

8. A collapsible handcart as claimed in claim 6, wherein each side frame includes one or more mounting arms extending from each quadrilateral and for pivotally mounting the quadrilaterals together.

9. A collapsible handcart as claimed in claim 2, wherein each side frame includes one or more elbows, each elbow including pivotally mounted members.

10. A collapsible handcart as claimed in claim 9, wherein each side frame includes an upper elbow and a lower elbow, the upper elbow including a pair of pivotally mounted upper lateral members, the lower elbow including a pair of pivotally mounted lower lateral members.

11. A collapsible handcart as claimed in claim 10, wherein each side frame includes one or more connection members for connecting the elbows, each connection member being of comparable length to the spacing of the elbows mounted to an end.

12. A collapsible handcart as claimed in claim 10, wherein each upper elbow forms at least part of a level load bearing platform, each upper elbow including a hinge which restricts hyperextension.

13. A collapsible handcart as claimed in claim 12, wherein each lower elbow forms an obtuse angle when the upper elbow forms the level load bearing platform to facilitate support of the platform and increase payload.

14. A collapsible handcart as claimed in claim 1, wherein the collapsible chassis includes one or more quadrilaterals with pivots at each corner.

15. A collapsible handcart as claimed in claim 1, wherein the collapsible chassis includes a pair of hinged front and back frames which collapse together.

16. A collapsible handcart as claimed in claim 15, wherein the frames can be collapsed together which causes the ends to come together whilst remaining substantially upright, wherein a user can lift the center of the chassis and the ends roll toward each other.

17. A collapsible handcart as claimed in claim 15, wherein each frame includes one or more quadrilaterals with pivots at each corner.

18. A collapsible handcart as claimed in claim 15, wherein the front frame includes a pair of front quadrilaterals for pivotally mounting to corresponding rear quadrilaterals of the rear frame, the front quadrilaterals being connected using one or more transverse joiner members.

19. A collapsible handcart as claimed in claim 15, wherein the rear frame includes a pair of rear quadrilaterals for pivotally mounting to corresponding quadrilaterals of the front frame, the rear quadrilaterals being connected using one or more transverse joiner members.

20. A collapsible handcart as claimed in claim 1, further including front and back wheels which overlap when the handcart is collapsed.
